(19) United States
(12) Patent Application Publication
(10) Pub. No.: US 2023/0167910 A1
(43) Pub. Date: Jun. 1, 2023

(54) CAVITY FILLER FOR A GATE VALVE

(71) Applicant: SPM Oil & Gas Inc., Fort Worth, TX (US)

(72) Inventor: Jarryd B. DANIELS, Houston, TX (US)

(21) Appl. No.: 18/048,514

(22) Filed: Oct. 21, 2022

Related U.S. Application Data
(60) Provisional application No. 63/264,633, filed on Nov. 29, 2021.

(51) Int. Cl. F16K 3/36

(52) U.S. Cl. CPC F16K 3/36

(57) ABSTRACT

In some implementations, a cavity filler for a gate valve may include a first body configured to be received within a cavity of the gate valve. The first body may include a first aperture configured to receive fluid passing through a fluid conduit of the gate valve, the fluid conduit defining a direction of flow. The first body may include a first lip, extending in a direction parallel to the direction of flow, configured to receive a gate of the gate valve. The cavity filler may include a second body configured to be received within the cavity of the gate valve. The second body may include a second aperture configured to receive the fluid passing through the fluid conduit. The second body may include a second lip, extending in the direction parallel to the fluid conduit, configured to receive the gate of the gate valve.

### CROSS-REFERENCE TO RELATED APPLICATION

This patent application claims priority to U.S. Provisional Patent Application No. 63/264,633, filed on Nov. 29, 2021, and entitled “CAVITY FILLER FOR A GATE VALVE.” The disclosure of the prior application is considered part of and is incorporated by reference into this patent application.

### TECHNICAL FIELD

The present disclosure relates generally to gate valves and, for example, to a cavity filler for a gate valve.

### BACKGROUND

A valve may enable or prevent flow of a medium through a conduit. For example, a valve may include a valve element that is moveably configured within a cavity formed in a valve housing. For example, for a gate valve, the valve element may be a gate that is movably mounted within a cavity of the gate valve. The gate may be configured to slide between an open position (e.g., that enables the flow of a medium through a conduit) and a closed position (e.g., that prevents the flow of the medium through the conduit).

For example, the cavity of the gate valve may facilitate the assembly or installation of the gate and/or other components of the gate valve. Due to the mechanical operation of the gate valve (e.g., due to the movement of components of the gate valve, such as the gate), a lubricant may be received within the cavity. For example, the cavity may be filled with a volume of the lubricant during operation of the gate valve (e.g., during an initial assembly of the gate valve, the cavity may be filled with the lubricant). Due to a size of the cavity needed to facilitate assembly of the gate value, a large volume of lubricant may be required to fill the cavity. Moreover, as the gate valve operates (e.g., as the gate moves between the open position and the closed position), lubricant may be lost from the cavity. For example, when the gate transitions between the open position and the closed position, lubricant may leak or pass through gaps between the moving components. As a result of the lost lubricant, the gate value may experience down time associated with re-filling the cavity of the gate valve with lubricant.

The cavity filler of the present disclosure solves one or more of the problems set forth above and/or other problems in the art.

### SUMMARY

In some implementations, a cavity filler for a gate valve includes a first body configured to be received within a cavity of the gate valve, wherein the first body includes a first aperture configured to receive fluid passing through a fluid conduit of the gate valve, the fluid conduit defining a direction of flow, and wherein the first body includes a first lip, extending in a direction parallel to the direction of flow, configured to receive a gate of the gate valve. The cavity filler may include a second body configured to be received within the cavity of the gate valve, wherein the second body includes a second aperture configured to receive the fluid passing through the fluid conduit, and wherein the second body includes a second lip, extending in the direction parallel to the direction of flow, configured to receive the gate of the gate valve.

In some implementations, a gate valve includes a housing defining a cavity, wherein the housing includes an outlet and an inlet for a fluid conduit that is configured between the outlet and the inlet, wherein the fluid conduit defines an axis. The gate valve may include a gate moveably configured within the cavity, wherein the gate is configured to be moveable between an open position and a closed position, and wherein the open position enables fluid to pass through the fluid conduit and the closed position prevents fluid from passing through the fluid conduit. The gate valve may include a cavity filler configured within the cavity, wherein the cavity filler occupies a volume of the cavity, and wherein the cavity filler includes one or more bodies that restrict a movement of the gate to a first direction that is perpendicular to the axis.

In some implementations, a cavity filler for a gate valve includes a body defining a substantially cylindrical configuration, a cylindrical axis, a top surface, a bottom surface, and an outer surface, wherein the body is configured to be received within a cavity of the gate valve. The cavity filler may include an aperture extending through the body in a first direction that is perpendicular to the cylindrical axis, wherein the aperture is configured to receive fluid passing through a fluid conduit of the gate valve. The cavity filler may include a channel extending through the body in a second direction that is parallel to the cylindrical axis, wherein the channel is configured to receive a gate of the gate valve, and wherein the channel is configured to restrict a movement of the gate to a plane that is parallel to the cylindrical axis.

### BRIEF DESCRIPTION OF THE DRAWINGS

FIG. 1 is a diagram of an example of a gate valve described herein.

FIG. 2 is a diagram of a cross-section top view of a gate valve described herein.

FIG. 3 is a diagram of a cross-section side view of an example gate valve described herein.

FIG. 4 is a diagram of a cross-section front view of an example gate valve described herein.

FIG. 5 is a diagram of a cross-section front view of an example gate valve described herein.

FIG. 6 is a diagram of a perspective view of an example cavity filler described herein.

FIG. 7 is a diagram of a top view of an example cavity filler described herein.

FIG. 8 is a diagram of a cross-section side view of an example cavity filler described herein.

FIG. 9 is a diagram of a perspective view of the example cavity filler described herein.

FIG. 10 is a diagram of a side view of the example cavity filler described herein.

FIG. 11 is a diagram of a perspective view of the example brace described herein.

FIG. 12 is a diagram of a perspective view of the example bracket described herein.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts. In some cases, a reference number will be indicated in this specification and the drawings will show the reference number followed by a letter (for example, 100a, 100b) or by a prime (for example, 100′, 100″). The use of letters or primes immediately after a reference number indicates that these features are similarly shaped and have a similar function, as may be the case when geometry is mirrored about a plane of symmetry. For ease of explanation herein, letters and primes will often not be included herein but may be shown in the drawings to indicate duplications of features, having a similar or identical function or geometry, discussed within this disclosure.

This disclosure relates to a cavity filler for a gate valve, which is applicable to any system in which a medium (e.g., fluid) is pumped or otherwise moved through a conduit. For example, the system may be a pumping system, a fluid pipeline, a hydraulic pump system, a fluid distribution system, an irrigation system, a power plant system, a mining system, an offshore drilling system, and/or any other system in which a medium is moved through a conduit. The gate valve may be used in applications involving slurries (e.g., where the medium is a slurry) and/or viscous liquids, such as oil, grease, varnish, molasses, and/or other viscous liquids. The system associated with the gate valve may be associated with an oil and gas application, a pharmaceutical application, a manufacturing application, an automotive application, and/or a marine application, among other examples.

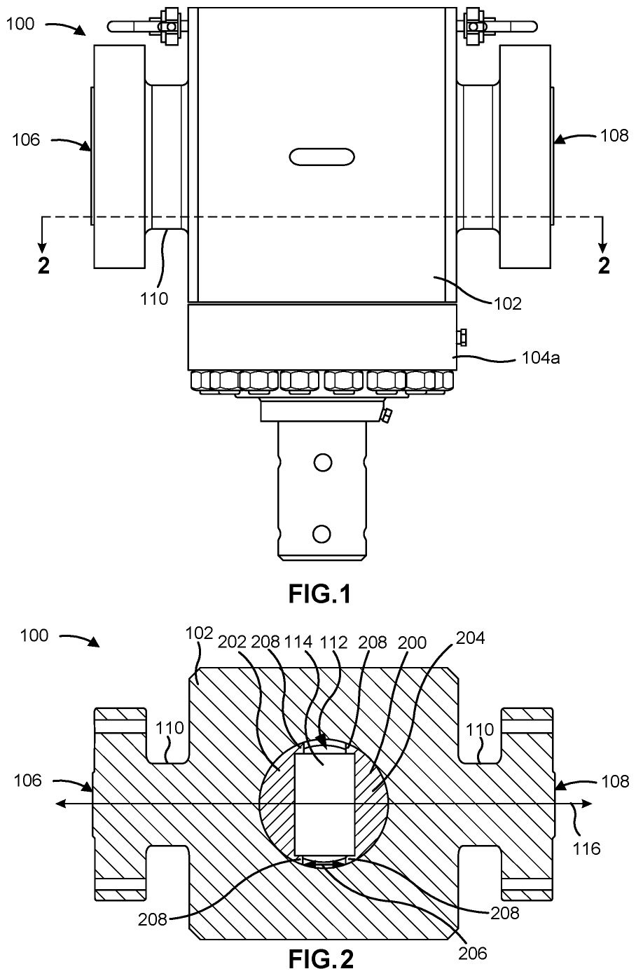

FIG. 1 is a diagram of an example of a gate valve 100 described herein. The gate valve 100 may also be referred to as a knife valve, a linear motion valve, and/or a slide valve, among other examples. The gate valve 100 depicted and described herein may be a through-conduit gate valve (e.g., in which the gate of the gate valve includes an aperture or an opening that corresponds to a fluid conduit of the gate valve, as depicted and described in more detail elsewhere herein). However, the cavity filler described herein may be used with other types of gate valves, such as knife valves, parallel gate valves, wedge-shaped gate valves (e.g., where the gate of the gate valve is wedge-shaped), a solid-wedge gate valve, a flexible-wedge gate valve, a disc gate valve (e.g., where the gate of the gate valve is disc-shaped), and/or other types of gate valves. For example, the cavity filler described herein may be used with any gate valve that includes a cavity.

The gate valve 100 may include a housing 102. The housing 102 may also be referred to as a body. The housing 102 may be formed from a metal, such as aluminum, steel, and/or another suitable metal. The housing 102 may include at least one bonnet 104. As shown in FIG. 1, the bonnet 104 may be attached to the housing 102. The bonnet 104 may be a lower bonnet 104a that is attached to a lower portion of the housing 102. The gate valve 100 may include an upper bonnet 104b (not shown in FIG. 1). The lower bonnet 104a and the upper bonnet 104b may be attached to the housing 102 via different means. For example, the lower bonnet 104a and the upper bonnet 104b may be removably attached to the housing 102 (e.g., to allow for disassembly of the gate valve 100 and to enable access to components of the gate valve 100 that are configured within the housing 102) or may be permanently attached to the housing 102. The lower bonnet 104a and the upper bonnet 104b may be attached to the housing 102 via one or more screws, one or more bolts, one or more welds, and/or a pressure seal, among other examples.

The gate valve 100 may include an inlet 106 and an outlet 108. The inlet 106 and the outlet 108 may be bores and/or apertures. The inlet 106 and the outlet 108 may each be configured to receive a pipe or other conduit of a system (e.g., a pumping system or another system described above). For example, the inlet 106 and the outlet 108 may provide a means to attach the gate valve 100 to the system. As shown in FIG. 1, the inlet 106 and the outlet 108 may each include a flange to enable the gate valve 100 to be attached to a pipe or other conduit of the system. The gate valve 100 may receive a medium (e.g., a fluid) being pumped or otherwise moved through the system via the inlet 106 and may return the medium to the system via the outlet 108, or vice versa. The terms “inlet” and “outlet” are used herein for ease of description and do not define a direction in which fluid flows through the gate valve 100. In some examples, the gate valve 100 may receive a medium via the outlet 108 and may return the medium via the inlet 106. In some implementations, the gate valve 100 may be bi-directional, such that a direction of flow through the gate valve 100 can be reversed. The inlet 106 and the outlet 108 may define a fluid conduit 110 of the gate valve 100. For example, the inlet 106 and the outlet 108 may define the fluid conduit 110. The fluid conduit 110 defines a pathway for fluid to move through the gate valve 100. For example, the fluid conduit 110 may extend from the inlet 106 to the outlet 108.

As indicated above, FIG. 1 is provided as an example. Other examples may differ from what is described with respect to FIG. 1.

FIG. 2 is a diagram of a cross-section top view of the gate valve 100 described herein. As shown in FIG. 2, the housing 102 may define a cavity 112. The cavity 112 may be formed in the housing 102. In some implementations, the cavity 112 may additionally be formed in the lower bonnet 104a and/or the upper bonnet 104b. The cavity 112 may be in fluid communication with the inlet 106, the outlet 108, and/or the fluid conduit 110. For example, the fluid conduit 110 may define a path for fluid to move through the gate valve 100, and the path may extend into, or pass through, the cavity 112.

The cavity 112 may provide access (e.g., for assembly and/or disassembly) to components that are installed within the housing 102. For example, the cavity 112 may enable an operator or a machine to access one or more components of the gate valve 100 (e.g., for maintenance, assembly, disassembly, and/or replacement purposes). As shown in FIG. 2, the cavity 112 may define a substantially circular configuration. For example, the cavity 112 may be a substantially cylindrical-shaped cavity. The substantially circular configuration of the cavity 112 may provide an ease of manufacturing and may provide improved access to the components of the gate valve 100 (e.g., as compared to other shapes of the cavity, such as a rectangular shaped cavity). The cavity 112 may be sized and/or shaped such that there is a space between walls of the cavity 112 and other components of the gate valve 100 when the gate valve 100 is assembled and/or in operation.

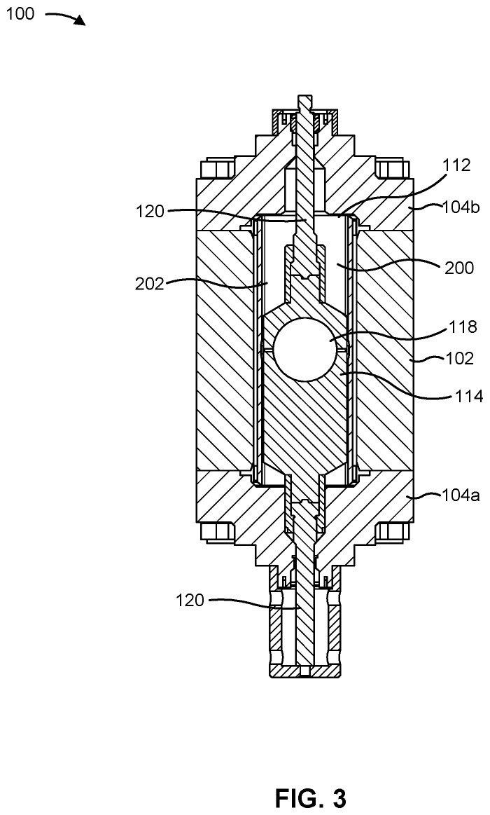

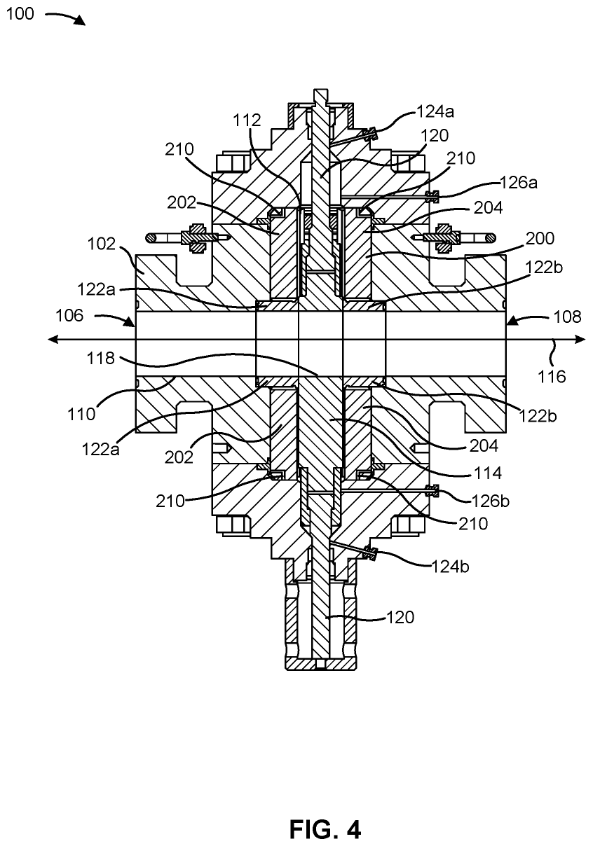

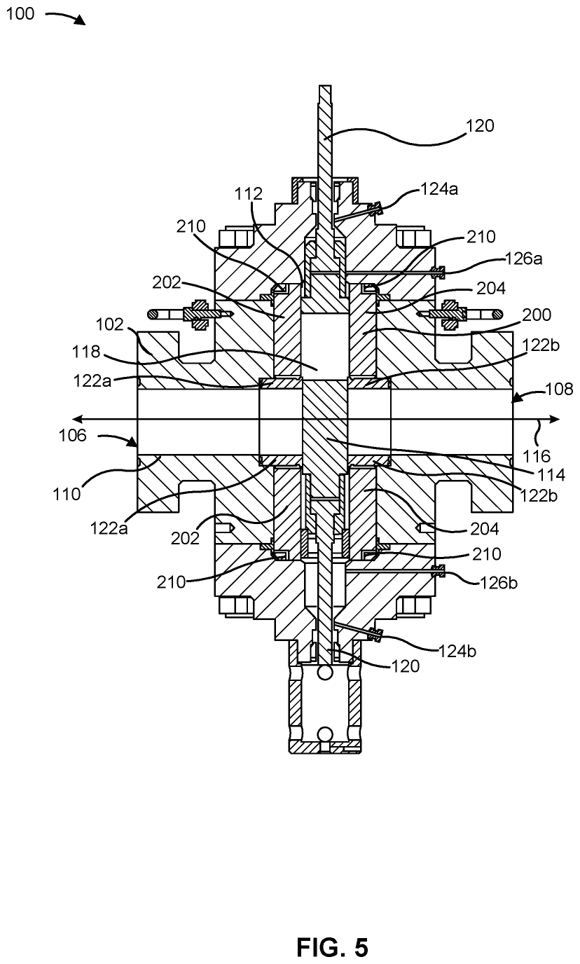

A gate 114 may be configured or installed within the cavity 112 of the gate valve 100. The gate 114 may be moveably configured within the cavity 112. For example, the gate 114 may be configured to be moveable between an open position (e.g., as depicted in FIG. 4) and a closed position (e.g., as depicted in FIG. 5). The open position may enable fluid to pass through the fluid conduit 110 and the closed position may prevent fluid from passing through the fluid conduit 110. For example, the gate 114 may have a substantially rectangular configuration. The gate 114 may move (e.g., slide) along a plane that is perpendicular to a direction of flow 116 that is defined by the fluid conduit 110. The direction of flow 116 may be an axis of the fluid conduit 110. The direction of flow 116 defines a path in which fluid moves through the gate valve 100. The gate 114 may include a through-bore 118 (e.g., depicted and described in more detail in connection with FIGS. 3 4, and 5) that enables fluid to travel through the fluid conduit when the gate 114 is configured in the open position. In some implementations, the gate 114 may not include the through-bore 118 and may be configured to block the flow of fluid through the fluid conduit 110 (e.g., in the closed position) and may be configured to allow the flow of fluid through the fluid conduit 110 by being moved out of the path of the fluid conduit 110 (e.g., in the open position).

A cavity filler 200 may be configured within the cavity 112. The cavity filler 200 may be a gate guide for the gate 114. For example, the cavity filler 200 may guide or restrict a movement of the gate 114. The cavity filler 200 may include a first body 202 and a second body 204. As shown in FIG. 2, the cavity filler 200 may be configured around the gate 114. For example, the gate 114 may include a first side and a second side. The first body 202 may be configured proximate to the first side of the gate 114 (e.g., relative to the direction of flow 116 or relative to an axis of the fluid conduit 110) and the second body may be configured proximate to the second side of the gate 114 (e.g., relative to the direction of flow 116 or relative to an axis of the fluid conduit 110). For example, the first body 202 may be configured in the cavity 112 of the gate valve 100 upstream relative to the gate 114 and the direction of flow 116. The second body 204 may be configured in the cavity 112 downstream relative to the gate 114 and the direction of flow 116. The terms “upstream” and “downstream” are used as relative terms for ease of description and do not define an actual direction in which fluid flows through the gate valve 100. In other words, the gate 114 may include a first side and a second side. The first body 202 may be configured within the cavity 112 proximate to the first side (e.g., relative to the direction of flow 116 or the axis defined by the fluid conduit 110). The second body 204 may be configured within the cavity 112 proximate to the second side (e.g., relative to the direction of flow 116 or the axis defined by the fluid conduit 110).

The cavity filler 200 may define a substantially circular cross-section. For example, the first body 202 and the second body 204 may define a substantially semicircular configuration. The first body 202 and the second body 204 may define the substantially circular cross-section of the cavity filler 200. The substantially circular cross-section of the cavity filler 200 may enable the cavity filler 200 to occupy a larger volume of the cavity 112 (e.g., because of the circular cross-section of the cavity 112). For example, the cavity 112 and the cavity filler 200 may both define a substantially circular cross-section. The first body 202 and the second body 204 may be separated by a distance 206 when configured within the cavity 112 of the gate valve 100. The distance 206 extends parallel to the direction of flow 116. The distance 206 may enable the gate 114 to be received by the cavity filler 200. For example, the distance 206 may define a channel in the cavity filler 200. The gate 114 may be received, by the cavity filler 200, in the channel.

The cavity filler 200 may include one or more lips 208. A lip 208 may extend from the first body 202 or the second body 204. For example, as shown in FIG. 2, a lip 208 may extend from the cavity filler in a direction that is parallel to the direction of flow 116. Each body of the cavity filler may include a lip 208. In some implementations, a body (e.g., the first body 202 and/or the second body 204) may include multiple lips 208. The lips 208 of the cavity filler 200 may define the channel in which the gate 114 is received by the cavity filler 200. For example, the bodies of the cavity filler 200 may restrict a movement of the gate 114 to a first direction that is perpendicular to the direction of flow 116 (e.g., that is perpendicular to an axis of the fluid conduit). For example, the first body 202, the second body 204, and the one or more lips 208 may define the channel extending through the cavity filler 200. The channel is configured to restrict a movement of the gate to a plane that is perpendicular to the direction of flow 116. For example, the first body 202 and the second body 204 may prevent a movement of the gate 114 in a direction (e.g., relative to the plane) that is parallel to the direction of flow 116 and the one or more lips may prevent a movement of the gate 114 in a direction (e.g., relative to the plane) that is perpendicular to the direction of flow 116. Additionally, the cavity filler 200 may restrict a rotational movement of the gate 114 relative to the plane (e.g., via the first body 202, the second body 204, and the one or more lips 208). As a result, the cavity filler 200 may guide a movement of the gate 114 to ensure that the gate 114 does not move out of position when configured within the cavity 112 and the gate valve 100. This may enable proper operation and movement of the gate 114.

As indicated above, FIG. 2 is provided as an example. Other examples may differ from what is described with respect to FIG. 2.

FIG. 3 is a diagram of a cross-section side view of an example gate valve 100 described herein. The side view of the gate valve 100 depicted in FIG. 3 may be from the plane of motion of the gate 114. In other words, the gate 114 may be enabled to move up (e.g., toward the upper bonnet 104b) or down (e.g., toward the lower bonnet 104a) along the plane of the cross-section side view. FIG. 3 depicts the gate valve 100 in an open position.

As described above, the gate 114 may include a through-bore 118. In the open position, the through-bore 118 may be aligned with the fluid conduit 110 (e.g., to enable fluid to pass through the fluid conduit 110). In the closed position, the gate 114 may move (e.g., slide) upwards (e.g., toward the upper bonnet 104b) such that a solid portion of the gate 114 (e.g., the portion below the through-bore 118) blocks the path of the fluid conduit 110. The gate 114 may be moved via a stem 120. The stem 120 may be attached to the gate 114. As an example, FIG. 3 depicts two stems 120, a first stem 120 attached to the top of the gate 114 and a second stem 120 attached to the bottom of the gate 114. The stem 120 may be a threaded stem. The housing 102 and/or a bonnet 104 may include a drive thread. When moving between the open position and the closed position, the stem 120 may rotate and move up or down (e.g., depending on a direction of rotation) via the drive thread. The stem 120 may be attached to an actuator (not shown) that causes the stem 120 to move up or down. The gate valve 100 may be a non-rising stem gate valve (e.g., in which the drive thread is included in the housing 102 and/or a bonnet 104). However, the cavity filler 200 may be used in a similar manner as described herein with a rising stem gate valve.

As shown in FIG. 3, the cavity 112 may extend into the lower bonnet 104a and the upper bonnet 104a. The cavity filler 200 may be configured within the cavity 112. The cavity filler 200 may include a single unitary body (e.g., the first body 202 or the second body 204) on each side of the gate 114 and the through-bore 118. For example, the first body 202 may be configured on a first side of the gate 114 (e.g., with a single unitary body above and below the through-bore 118). The second body 204 (not shown in FIG. 3) may be configured on a second side of the gate 114 (e.g., with a single unitary body above and below the through-bore 118).

As indicated above, FIG. 3 is provided as an example. Other examples may differ from what is described with respect to FIG. 3.

FIGS. 4 and 5 are diagrams of cross-section front views of the example gate valve 100 described herein. FIG. 4 depicts an example of the gate valve 100 in the open position. FIG. 5 depicts an example of the gate valve 100 in the closed position. As shown in FIG. 4, in the open position, the through-bore 118 of the gate 114 may be aligned with the fluid conduit 110 to enable fluid to move through the fluid conduit 110. As shown in FIG. 5, in the closed position, a solid portion of the gate 114 may block the path of the fluid conduit 110 to prevent fluid from moving through the fluid conduit 110. For example, to transition to the closed position, the gate 114 may move up (e.g., via the stem 120), such that the through-bore 118 of the gate 114 is no longer aligned with the fluid conduit 110. To transition to the open position, the gate 114 may move down (e.g., via the stem 120), such that the through-bore 118 of the gate 114 is aligned with the fluid conduit 110. Alternatively, the gate 114 may move up to transition to the open position and may move down to transition to the closed position. The gate 114 may move in a direction that is transverse to the direction of flow 116. For example, the gate 114 may move (e.g., between the open position and the closed position) in a direction that is substantially perpendicular to the direction of flow 116.

One or more valve seats 122 may be configured within the cavity 112. For example, a first valve seat 122a and a second valve seat 122b may be configured within the cavity 112. A valve seat 122 may define a substantially annular configuration. For example, the valve seat 122 may extend around the fluid conduit 110. The valve seat 122 may be a seal. For example, the valve seat 122 may provide a seal for the gate 114 to prevent fluid from passing between the fluid conduit 110 and the cavity 112. The valve seat 122 may form a seal with the gate 114 and the housing 102. For example, the valve seat 122 may contain an O-ring seal or another type of seal. The valve seat 122 may be integral with the housing 102. For example, the valve seat 122 may be made of a similar (or the same) material as the housing 102 and may be permanently attached to the housing 102 (e.g., via a weld). Alternatively, the valve seat 122 may not be integral with the housing 102. For example, the valve seat may be threaded or pressed into position and seal welded to the housing 102. The cavity filler 200 may be configured proximate to the valve seat 122. For example, a body or portion of the cavity filler 200 may be configured around a valve seat 122. The first body 202 may be configured around the first valve seat 122a and the second body 204 may be configured around the second valve seat 122b.

The gate valve 100 may include one or more fluid inlets 124 and 126. The one or more fluid inlets 124 and 126 may enable fluid to be added to the cavity 112 and/or be removed from the cavity 112. For example, a lubricant (e.g., grease) may be added to the cavity 112 via a first fluid inlet 124a and/or a second fluid inlet 124b. The lubricant may be added to the cavity 112 via a third fluid inlet 126a and/or a fourth fluid inlet 126b. The fluid inlets 124 and 126 may be positioned to enable lubricant to be added to various locations within the gate valve 100. For example, fluid inlets 124 and 126 may be configured to enable lubricant to be added to the gate valve 100 proximate to locations where components of the gate valve are moving. In some examples, a fluid inlet (e.g., the first fluid inlet 124a, the second fluid inlet 124b, the third fluid inlet 126a, and/or the fourth fluid inlet 126b) may be used to drain fluid, lubricant, or other debris from the cavity 112.

The cavity filler 200 may occupy a volume of the cavity 112. For example, the cavity filler 200 may occupy between 40% and 70% of the volume of the cavity 112 (e.g., of the open space defined by the cavity that would be unoccupied without the cavity filler 200 being configured within the cavity 112). More specifically, the cavity filler 200 may occupy approximately 50% of the volume of the cavity 112. This may enable the cavity filler 200 to reduce a volume of lubricant required to fill the cavity 112.

The cavity filler 200 may include one or more fluid pathways 210. The one or more fluid pathways 210 may be disposed on the first body 202 and/or the second body 204. The one or more fluid pathways 210 may enable fluid to pass between a first surface of the cavity filler 200 and a second surface of the cavity filler 200. For example, the one or more fluid pathways 210 may enable fluid volume and/or pressure to be equalized between the first surface and the second surface of the cavity filler 200. This may prevent a seal from forming between the cavity filler 200 and a wall of the cavity 112. For example, this may prevent a seal from forming between the top surface 212 of the cavity filler 200 and a surface on the upper bonnet 104b or the bottom surface 214 of the cavity filler 200 and a surface on the lower bonnet 104a. In other words, the one or more fluid pathways 210 may be safety features of the cavity filler 200. The one or more fluid pathways 210 are depicted and described in more detail elsewhere herein.

As indicated above, FIGS. 4 and 5 are provided as examples. Other examples may differ from what is described with respect to FIGS. 4 and 5.

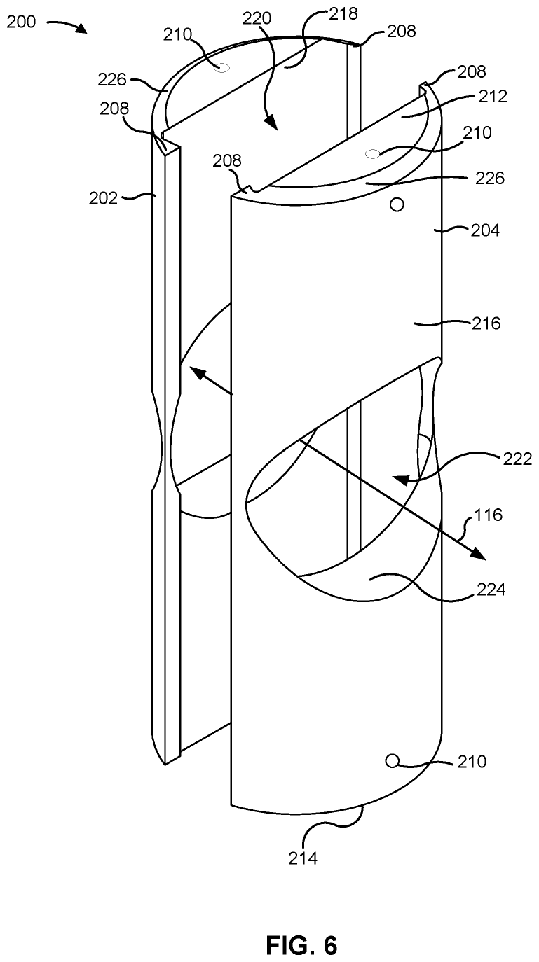

FIG. 6 is a diagram of a perspective view of the example cavity filler 200 described herein. As described above, the cavity filler 200 may include a first body 202 (e.g., a first portion) and a second body 204 (e.g., a second portion). While examples depicted herein show the cavity filler 200 including two bodies or portions, the cavity filler 200 may include a different number of bodies or portions. For example, the cavity filler 200 may include a single portion (e.g., the first body 202 and the second body 204 may be connected, such as at the lips 208), four portions (e.g., the first body 202 may include a first portion and a second portion and the second body 204 may include a third portion and a fourth portion), or another number of portions. For example, the first body 202 may include an upper portion and a lower portion (e.g., that are separated by a distance) and the second body 204 may include an upper portion and a lower portion (e.g., that are separated by a distance).

Each body (e.g., the first body 202 and the second body 204) may include a top surface 212, a bottom surface 214, an outer surface 216, and an inner surface 218. The top surface 212 and the bottom surface 214 may be substantially flat surfaces. The outer surface 216 may be a rounded surface (e.g., defining the circular cross-section of the cavity filler 200). The inner surface 218 may be a substantially flat surface. The inner surface 218 and the outer surface 216 may extend in a direction that is substantially perpendicular to the direction of flow 116. The top surface 212 and the bottom surface 214 may extend in a direction that is substantially parallel to the direction of flow 116. The inner surfaces 218 of the first body 202 and the second body 204 may define a channel 220. The channel 220 may also be referred to herein as an aperture. The channel 220 may be configured to receive the gate 114 of the gate valve 100, as described in more detail elsewhere herein. For example, the inner surface may be a substantially flat surface to define a rectangular cross-section of the channel 220 (e.g., to enable the gate 114 having a rectangular cross-section to be moveably received by the channel 220), whereas the outer surface 216 may be rounded to define the circular cross-section of the cavity filler 200 (e.g., to enable the cavity filler 200 to occupy a greater volume of the cavity 112 that has a circular cross-section).

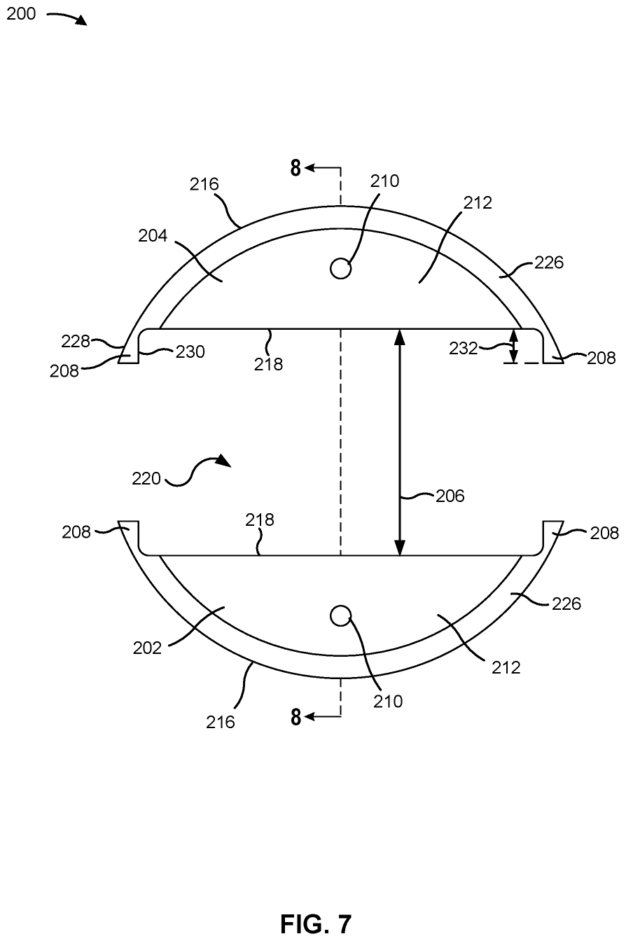

The cavity filler 200 may include one or more lips 208. The one or more lips 208 may extend from the first body 202 and/or the second body 204 in a direction that is parallel to the direction of flow 116. For example, the one or more lips 208 may extend from the inner surface 218 into the channel 220. The first body 202 may include a first lip 208 and a second lip 208. Similarly, the second body 204 may include a first lip 208 and a second lip 208. A lip 208 may extend from an intersection of the inner surface 218 and the outer surface 216 of a body of the cavity filler 200. A lip 208 may extend along the length of a body of the cavity filler 200 (e.g., in a direction that is perpendicular to the direction of flow 116). The first body 202, the second body 204, and the one or more lips 208 may define the channel 220. For example, the first body 202, the second body 204, and the one or more lips 208 may define the rectangular cross-section of the channel 220 (e.g., as shown in FIG. 7).

The cavity filler 200 may include an aperture 222. The aperture 222 may be configured to receive fluid passing through the fluid conduit 110 of the gate valve 100. For example, the first body 202 may include a first aperture 222 configured to receive, or correspond to, the fluid conduit 110. The second body 204 may include a second aperture 222 configured to receive, or correspond to, the fluid conduit 110. The aperture 222 may define a substantially circular cross-section. The size and/or cross-section of the aperture 222 may be based on a size and/or cross-section of the fluid conduit 110. For example, the size and/or cross-section of the aperture 222 may be configured to receive, or correspond to, the fluid conduit 110. The aperture 222 may extend into the first body 202 and/or the second body 204 in a direction that is parallel to the direction of flow 116. The aperture 222 may be configured to receive a valve seat 122 of the gate valve 100. For example, a valve seat 122 may be configured to be received in the aperture 222 (e.g., at an inner surface 224 of the aperture 222).

A fluid pathway 210 may be disposed on the top surface 212, the bottom surface 214, the outer surface 216, and/or the inner surface 218 of a body of the cavity filler 200. For example, a safety feature may be a fluid pathway that enables fluid to pass between two surfaces of the cavity filler 200. For example, a first surface may be the top surface 212 or the bottom surface 214 and a second surface may be the outer surface 216 or the inner surface 218. The fluid pathway 210 may define a fluid pathway that enables fluid to pass between the first surface and the second surface. A body (e.g., the first body 202 and/or the second body 204) may include one or more safety features. For example, the first body 202 and/or the second body 204 may each include multiple fluid pathways 210.

The first body 202 and/or the second body 204 may include one or more chamfers 226. For example, one or more edges of the first body 202 and/or the second body 204 may be beveled. For example, an intersection between the top surface 212 or the bottom surface 214 and the outer surface 216 may include a chamfer 226. The one or more chamfers 226 may improve safety and/or prevent damage to the cavity filler 200. Additionally, the one or more chamfers 226 may ease assembly and/or installation of the cavity filler 200 within the cavity 112 of the gate valve 100.

As indicated above, FIG. 6 is provided as an example. Other examples may differ from what is described with respect to FIG. 6.

FIG. 7 is a diagram of a top view of the example cavity filler 200 described herein. The first body 202 and the second body 204 of cavity filler 200 (e.g., when configured within the cavity 112 of the gate valve 100) may be separated by the distance 206. The distance 206 may be relative to the inner surface 218 of the first body 202 and the inner surface 218 of the second body 204. The distance 206 may be configured to enable the gate 114 of the gate valve 100 to be received within the channel 220 of the cavity filler 200.

The circular cross-section of the cavity filler 200 is depicted in FIG. 7. For example, the first body 202 may define a substantially semicircular configuration configured to be received within the cavity 112 of the gate valve 100. Similarly, the second body 204 may define a substantially semicircular configuration configured to be received within the cavity 112 of the gate valve 100. Together, the first body 202 and the second body 204 define the circular cross-section of the cavity filler 200.

The channel 220 may have a substantially rectangular cross-section that is defined by the inner surface 218 of the first body 202, the inner surface 218 of the second body 204, and the one or more lips 208. The example described herein includes four lips 208 (e.g., two lips 208 disposed on each body of the cavity filler 200). However, other numbers of lips 208 are possible. A lip 208 may extend from an intersection of the inner surface 218 and the outer surface 216 of a body of the cavity filler 200. Each lip 208 may include an outer surface 228 and an inner surface 230. The outer surface 228 may be rounded. For example, the outer surface 228 of the lip 208 may have a similar (or the same) radius as the outer surface 216 (e.g., of the first body 202 and/or the second body 204). The inner surface 230 may be a flat surface. The inner surface 230 may be substantially perpendicular to the inner surface 218 (e.g., of the first body 202 and/or the second body 204). For example, the inner surfaces 230 of the one or more lips 208 (e.g., in combination with the inner surfaces 218 of the first body 202 and/or the second body 204) may define the channel 220 that is configured to receive the gate 114. In other words, the inner surfaces 230 of the one or more lips 208 may define the rectangular cross-section of the channel 220, whereas the outer surfaces 228 of the one or more lips 208 define the circular cross-section of the cavity filler 200. This may enable the gate 114 (e.g., that has a rectangular cross-section) to be received within the channel 220 and may enable the cavity filler 200 to restrict a movement of the gate 114. Additionally, the outer surfaces 228 of the one or more lips 208 may define the circular cross-section that enables the cavity filler 200 to occupy additional volume of the cavity 112.

The one or more lips 208 may extend a distance 232 away from the inner surface 218 (e.g., of the first body 202 and/or the second body 204). The distance 232 may be configured to restrict a movement of the gate 114, as described in more detail elsewhere herein. As shown in FIG. 7, each lip 208 may include a rounded corner at an intersection of the inner surface 230 of the lip 208 and the inner surface 218 (e.g., of the first body 202 and/or the second body 204). The rounded corner may allow ease of manufacturing of the cavity filler 200.

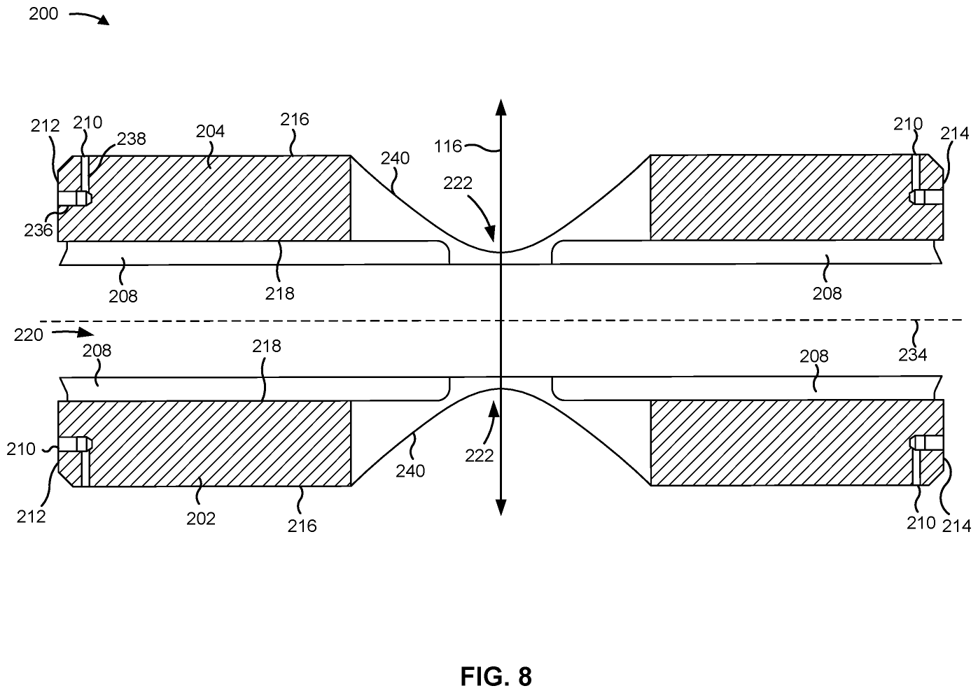

The cavity filler 200 may restrict a movement of the gate 114. For example, the cavity filler 200 may restrict a movement of the gate 114 (e.g., when configured within the cavity 112 of the gate valve 100) to a first direction that is perpendicular to an axis defined by the fluid conduit 110 (e.g., to a first direction that is perpendicular to the direction of flow 116). As another example, the cavity filler 200 may restrict a movement of the gate 114 to a plane 234 (shown in FIG. 8) that is parallel to an axis defined by the circular cross-section of the cavity filler 200. For example, the first body 202 and the second body 204 may define a cylindrical axis of the cavity filler 200. The cylindrical axis may be along the plane 234 (e.g., as depicted in FIG. 8). The first body 202 (e.g., the inner surface 218 of the first body 202) and the second body 204 (e.g., the inner surface 218 of the second body 204) may restrict or prevent a movement of the gate 114 in a first direction relative to the plane 234 (e.g., may restrict a front-to-back movement of the gate 114). The one or more lips 208 may restrict or prevent a movement of the gate 114 in a second direction relative to the plane 234 (e.g., may restrict a side-to-side movement of the gate 114). The first body 202 (e.g., the inner surface 218 of the first body 202), the second body 204 (e.g., the inner surface 218 of the second body 204), and the one or more lips 208 may restrict or prevent a rotational movement of the gate 114 relative to the plane 234. For example, an interface between the cavity filler 200 (e.g., between the first body 202 or the second body 204) and a valve seat 122 may prevent a rotational movement of the gate 114. An interface between a surface of the aperture 222 and the valve seat 122 may restrict or prevent a rotational movement of the gate 114 relative to the plane 234. As a result, a movement of the gate 114 may be guided (e.g., by the cavity filler 200) to a single direction (e.g., up and down) along the plane 234, thereby ensuring proper movement and operation of the gate valve 100.

As indicated above, FIG. 7 is provided as an example. Other examples may differ from what is described with respect to FIG. 7.

FIG. 8 is a diagram of a cross-section side view of the example cavity filler 200 described herein. As shown in FIG. 8, the one or more lips 208 may extend a distance along the inner surface 218 of a body (e.g., the first body 202 or the second body 204) of the cavity filler 200 (e.g., in a direction that is parallel to the plane 234). In some examples, a lip 208 may extend along the entire length of the inner surface 218. In some other examples, a lip 208 may not extend along the entire length of the inner surface 218 (e.g., there may be a portion of the inner surface 218 that does not include the lip 208, such as proximate to the aperture 222, to enable an improved seal with the fluid conduit 110).

The one or more fluid pathways 210 may include fluid pathways. For example, a fluid pathway 210 may include a first fluid pathway 236 and a second fluid pathway 238. The first fluid pathway 236 may extend from the top surface 212 or the bottom surface 214 of a body (e.g., the first body 202 or the second body 204) of the cavity filler 200. The second fluid pathway 238 may extend from the outer surface 216 of a body (e.g., the first body 202 or the second body 204) of the cavity filler 200. The first fluid pathway 236 and the second fluid pathway 238 may be connected to enable fluid to pass between the top surface 212 or the bottom surface 214 and the outer surface 216. The first fluid pathway 236 and/or the second fluid pathway 238 may be channels or holes through the cavity filler 200. The first fluid pathway 236 may have a larger diameter than the second fluid pathway 238 (e.g., the first fluid pathway 236 may also contain an internal thread to assist moving the component around during assembly with the valve housing 102). The first fluid pathway 236 and/or the second fluid pathway 238 may enable fluid pressure and/or volume equalization between the top surface 212 or the bottom surface 214 and the outer surface 216 (e.g., to prevent a seal from forming). The first fluid pathway 236 and/or the second fluid pathway 238 may enable fluid to be equally spread around different areas of the cavity filler 200 to ensure proper lubrication of moving components of the gate valve 100. As shown in FIG. 8, each intersection between the top surface 212 or the bottom surface 214 and the outer surface 216 may include a fluid pathway 210 (e.g., the cavity filler 200 may include 4 fluid pathways 210). In some examples, the cavity filler 200 may include more or fewer fluid pathways 210. For example, the cavity filler 200 may include a safety feature between the top surface 212 or the bottom surface 214 and the inner surface 218 (e.g., in a similar manner as shown in FIG. 8).

In some implementations, the one or more fluid pathways 210 may include one or more channels extending into the outer surface 216 of the cavity filler 200. For example, one or more channels or grooves may be formed in the outer surface 216 to enable fluid and/or lubricant to travel to different areas of the cavity filler 200 (e.g., to ensure proper lubrication of moving components of the gate valve 100). The one or more channels or grooves may be formed along the outer surface 216 in a direction that is substantially parallel to the plane 234.

The outer surface 216 of a body (e.g., the first body 202 and/or the second body 204) of the cavity filler 200 may include an aperture 240. The aperture 240 may be disposed proximate to, or corresponding to, the aperture 222. For example, the aperture 240 may extend around the aperture 222 in the outer surface 216 of each body (e.g., the first body 202 and the second body 204) of the cavity filler 200. The aperture 240 may be configured to receive one or more other components of the gate valve 100, such as the valve seat 122. An interface between a surface of the aperture 240 and the valve seat 122 may prevent or restrict a rotational movement of the gate 114 relative to the plane 234.

As indicated above, FIG. 8 is provided as an example. Other examples may differ from what is described with respect to FIG. 8.

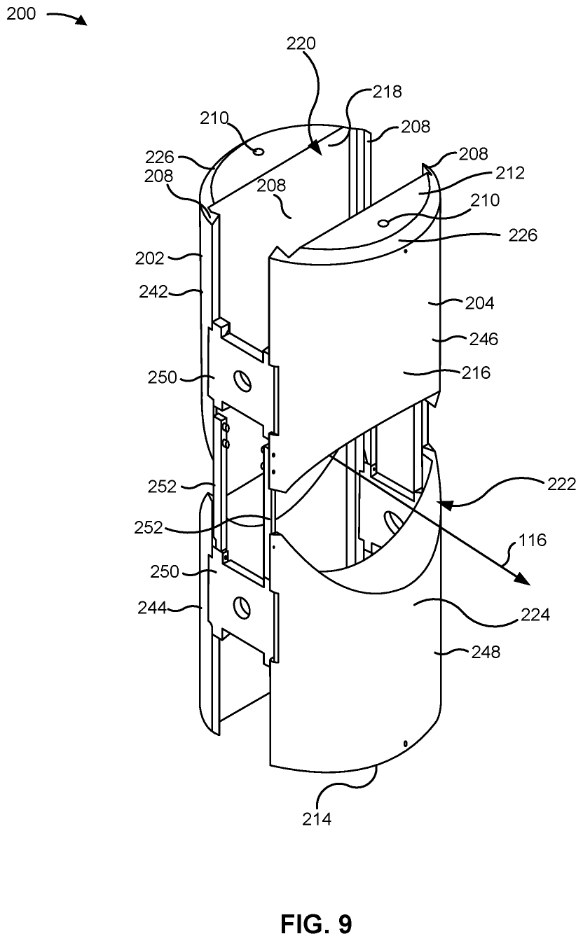

FIG. 9 is a diagram of a perspective view of the example cavity filler 200 described herein. As described above, the cavity filler 200 may include the first body 202 (e.g., a first portion) and the second body 204 (e.g., a second portion). In some implementations, as shown in FIG. 9, the cavity filler 200 may include four portions (e.g., the first body 202 may include a first portion and a second portion and the second body 204 may include a third portion and a fourth portion). For example, the first body 202 may include an upper portion 242 and a lower portion 244 (e.g., that are separated by a distance) and the second body 204 may include an upper portion 246 and a lower portion 248 (e.g., that are separated by a distance).

In other implementations, the first body 202 may be an upper portion (e.g., a combination of the upper portion 242 and the upper portion 246 as shown in FIG. 9) and the second body 204 may be a lower portion (e.g., a combination of the lower portion 244 and the lower portion 248). For example, the upper portion 242 and the upper portion 246 may be mechanically connected and/or may be a single unitary piece defining the first body 202 and/or the upper portion of the cavity filler 200. The lower portion 244 and the lower portion 248 may be mechanically connected and/or may be a single unitary piece defining the second body 204 and/or the lower portion of the cavity filler 200. In other words, the first body 202 may be configured in the cavity 112 of the gate valve 100 above the second body 204 with respect to the fluid conduit 110 and/or the aperture 222.

For example, the upper portion 242 and the upper portion 246 may define an upper portion of the aperture 222. The lower portion 244 and the lower portion 248 may define a lower portion of the aperture 222. The upper portion 242 and the lower portion 244 may be separate pieces and/or may not be connected when installed within the cavity 112. Similarly, the upper portion 246 and the lower portion 248 may be separate pieces and/or may not be connected when installed within the cavity 112. This may facilitate a removal of the cavity filler 200 from the cavity 112 and/or may reduce a likelihood of damage to the cavity filler 200 during removal from the cavity 112, as described in more detail elsewhere herein.

In some implementations, the upper portion 242 and the upper portion 246 may be connected (e.g., mechanically connected) via a first one or more brackets 250. Similarly, the lower portion 244 and the lower portion 248 may be connected (e.g., mechanically connected) via a second one or more brackets 250. For example, a first bracket 250 may be mechanically connected (e.g., via one or more bolts, screws, and/or a welded connection, among other examples) to the upper portion 242 and the upper portion 246. A second bracket 250 may be mechanically connected (e.g., via one or more bolts, screws, and/or a welded connection, among other examples) to the lower portion 244 and the lower portion 248. In some implementations, the upper portion 242 and the upper portion 246 may be connected (e.g., mechanically connected) via two brackets 250. Similarly, the lower portion 244 and the lower portion 248 may be connected (e.g., mechanically connected) via two brackets 250.

As shown in FIG. 9, the cavity filler 200 may include one or more braces 252. The one or more braces 252 may extend between the first body 202 and the second body 204 (e.g., between the upper portion 242 and the lower portion 244 and/or between the upper portion 246 and the lower portion 248). The one or more braces 252 may be configured to prevent a rotation of the first body 202 with respect to the second body 204. For example, the one or more braces 252 may be configured to prevent a rotation of the upper portion 242 and the upper portion 246 with respect to the lower portion 244 and the lower portion 248. This may ensure that the aperture 222 remains aligned with the fluid conduit 110 (e.g., because the upper portion 242 and the upper portion 246 may be unable to rotate with respect to the lower portion 244 and the lower portion 248).

As indicated above, FIG. 9 is provided as an example. Other examples may differ from what is described with respect to FIG. 9.

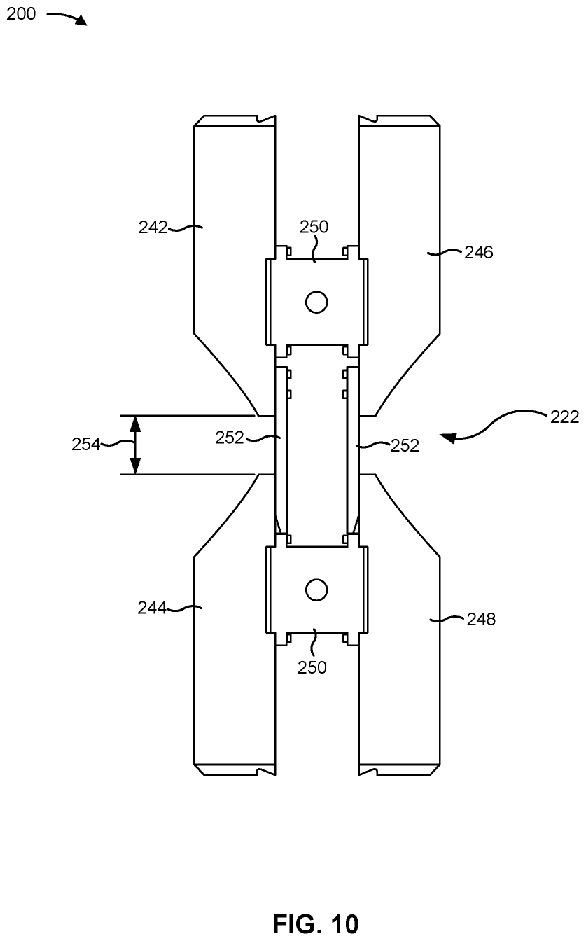

FIG. 10 is a diagram of a side view of the example cavity filler 200 described herein.

As shown in FIG. 10, the one or more braces 252 may be configured to contact a surface of a bracket 250. For example, a brace 252 may be mechanically or permanently connected to only one of an upper portion (e.g., upper portion 242 or the upper portion 246) or a lower portion (e.g., the lower portion 244 or the lower portion 248). For example, as shown in FIG. 10, a brace 252 may be mechanically or permanently connected to the upper portion 242 and may be configured to contact a bracket 250 that is connected to the lower portion 244. Similarly, a brace 252 may be mechanically or permanently connected to the upper portion 246 and may be configured to contact a bracket 250 that is connected to the lower portion 248. The one or more braces 252 may have a length that is configured based on a diameter of the aperture 222. For example, the one or more braces 252 may have a length such that when the upper portion 242 and the lower portion 244 are installed within the cavity 112 (e.g., with the brace 252 contacting the bracket 250), the aperture 222 has the diameter as defined by the upper portion 242 and the lower portion 244.

The upper portions (e.g., the upper portion 242 and the upper portion 246) may be separated from the lower portions (e.g., the lower portion 244 and the lower portion 248) by a distance 254. For example, when the cavity filler 200 is configured within the cavity 112, the upper portions of the cavity filler 200 may be separated from the lower portions of the cavity filler 200 by the distance 254. In other words, the upper portion(s) of the cavity filler 200 and the lower portion(s) of the cavity filler 200 may be separated (e.g., not touching other than at the brace(s) 252) and/or may be separate pieces. This may enable the upper portion(s) of the cavity filler 200 and the lower portion(s) of the cavity filler 200 to be separately installed and/or removed from the cavity 112. Further, this may ensure that no portions of the cavity filler 200 (e.g. upper portions 242 and 246 or lower portions 244 and 248) contact the one or more valve seats 122 when the cavity filler 200 is installed within the cavity 112.

In some implementations, the distance 254 may enable a valve seat 122 to be received by the cavity filler 200. For example, because the cavity filler 200 may be separated into an upper and lower portion (e.g., relative to the direction of flow 116), the distance separating the upper and lower portions (e.g., the distance 254) may enable the one or more valve seat 122 to be received by the cavity filler 200. In such examples, one or more braces 252 and/or one or more brackets 250 included in the cavity filler 200 may enable the cavity filler 200 to receive the gate 114. For example, the one or more braces 252 may extend the channel 220 from the upper portion to the lower portion of the cavity filler 200 (e.g., preventing a movement of the gate 114, as described in more detail elsewhere herein). Additionally, the one or more brackets 250 may define a structure of the channel 220.

As indicated above, FIG. 10 is provided as an example. Other examples may differ from what is described with respect to FIG. 10.

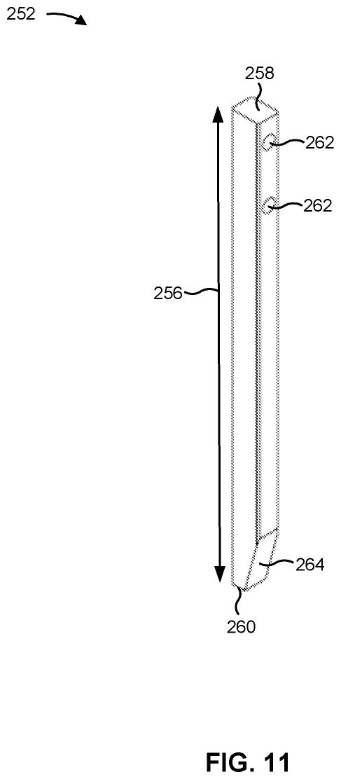

FIG. 11 is a diagram of a perspective view of the example brace 252 described herein.

The brace 252 may have a length 256. The length 256 may be configured based on a diameter of the aperture 222. For example, the brace 252 may have the length 256 such that when an upper portion and a lower portion are installed within the cavity 112 (e.g., with the brace 252 contacting a bracket 250), the aperture 222 has the diameter as defined by the upper portion and the lower portion.

The brace 252 may include a first end 258 and a second end 260. The first end 258 may be an end of the brace 252 at which the brace 252 is attached to an upper portion (e.g., the upper portion 242 or the upper portion 246) or a lower portion (e.g., the lower portion 244 or the lower portion 248). For example, the brace 252 may include one or more through holes 262 configured to accept a fastener (e.g., a bolt, a screw, or another fastener) proximate to the first end 258.

The second end 260 may be a free end that is not attached to another member of the cavity filler 200. For example, the second end 260 may contact a bracket 250 when the cavity filler 200 is installed within the cavity 112. In some implementations, the second end 260 may include an angled face 264. For example, the angled face 264 may be a chamfer edge. The angled face 264 may facilitate the bracket 250 being inserted into the channel 220 defined by an upper portion (e.g., the upper portion 242 and the upper portion 246) or a lower portion (e.g., the lower portion 244 and the lower portion 248).

As indicated above, FIG. 11 is provided as an example. Other examples may differ from what is described with respect to FIG. 11.

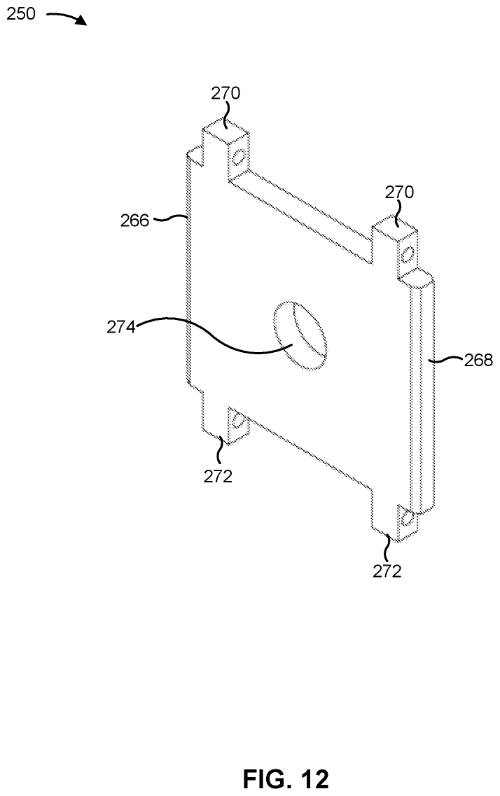

FIG. 12 is a diagram of a perspective view of the example bracket 250 described herein.

As described above, the bracket 250 may be configured to connect the upper portion 242 to the upper portion 246 and/or the lower portion 244 to the lower portion 248. For example, a first side 266 may be connected to the upper portion 242 (or the lower portion 244) and a second side 268 may be connected to the upper portion 246 (or the lower portion 248).

The bracket 250 may include a first face 270 and a second face 272. The first face 270 and/or the second face 272 may be configured to contact the brace 252 (e.g., the second end 260 of the brace 252). For example, the brace 252 may sit on the first face 270 or the second face 272 of the bracket 250 (e.g., to separate the upper portion(s) of the cavity filler 200 from the lower portion(s) of the cavity filler 200). In some implementations, the bracket 250 may include a through hole 274. The through hole 274 may facilitate a removal of the cavity filler 200 from the cavity 112. For example, the through hole 274 may be configured to receive a tool or other device used to pull the cavity filler 200 from the cavity 112.

As indicated above, FIG. 12 is provided as an example. Other examples may differ from what is described with respect to FIG. 12.

### INDUSTRIAL APPLICABILITY

In order to facilitate the manufacture and assembly of a gate valve, the valve housing may include the cavity. For example, the cavity may facilitate the assembly or installation of the gate and/or other components of the gate valve. Due to the mechanical operation of the gate valve (e.g., due to the movement of components of the gate valve, such as the gate), a lubricant may be received within the cavity. For example, the cavity may be filled with a volume of the lubricant during operation of the gate valve (e.g., during an initial assembly of the gate valve, the cavity may be filled with the lubricant). Due to a size of the cavity needed to facilitate assembly of the gate value, a large volume of lubricant may be provided to fill the cavity. Moreover, as the gate valve operates (e.g., as the gate moves between the open position and the closed position), lubricant may be lost from the cavity. For example, when the gate transitions between the open position and the closed position, lubricant may leak or pass through gaps between the moving components. As a result of the lost lubricant, the gate value may experience down time associated with re-filling the cavity of the gate valve with lubricant.

Additionally, the gate of the gate valve may be displaced due to forces applied to the gate during operation (e.g., by the fluid passing through the fluid conduit of the gate valve). The forces may cause the gate to move or twist, causing the gate to become misaligned with the fluid conduit and/or an intended path of movement of the gate. This may cause the gate valve to fail, resulting in additional maintenance and down time associated with repairing and/or re-aligning the gate.

Some implementations described herein enable a cavity filler (e.g., the cavity filler 200) that occupies a volume of the cavity of the gate valve. For example, when configured within the cavity of the gate valve, the cavity filler may occupy what would have otherwise been empty space. As a result, a volume of lubricant required to fill the cavity may be reduced. This may reduce an amount of time associated with re-filling the cavity of the gate valve with lubricant (e.g., may reduce a maintenance time and/or a down time of the gate valve). In some implementations, the cavity filler may have a substantially circular cross-section to enable the cavity filler to occupy a greater volume of the cavity (e.g., where the cavity also has a circular cross-section).

Additionally, the cavity filler may restrict a movement of the gate of the gate valve. For example, the cavity filler may be a gate guide for the gate. The cavity filler may include one or more lips (e.g., that extend in a direction that is substantially parallel with a direction of flow of the gate valve). The one or more lips may be configured to receive the gate and to restrict or prevent a movement of the gate. For example, the cavity filler (e.g., one or more bodies of the cavity filler and/or the one or more lips) may restrict a movement of the gate to a single plane and/or a single direction (e.g., the gate may be enabled to move up and down along a plane, but may be prevented from moving left-to-right relative to the plane, from moving front-to-back relative to the plane, and/or from rotation relative to the plane). As a result, the cavity filler may ensure that the gate of the gate valve remains aligned with the fluid conduit of the gate valve as the gate moves between an open position and a closed position. This may reduce a likelihood that the gate becomes misaligned due to forces applied to the gate during operation of the gate valve, thereby reducing a maintenance time and/or a down time associated with repairing and/or re-aligning the gate.

In some implementations, the cavity filler may include one or more safety features. The one or more safety features may enable fluid to pass between a first surface of the cavity filler and a second surface of the cavity filler. For example, the one or more safety features may prevent the cavity filler from forming a seal with an inner surface or wall of the cavity of the gate valve or with a surface of a bonnet of the gate valve. As a result, this may reduce an amount of force applied to the cavity filler. Additionally, this may ensure that fluid volume and/or fluid pressure is equalized between the first surface of the cavity filler and the second surface of the cavity filler.

In some implementations, the cavity filler may include an upper portion and a lower portion (e.g., separate upper portion(s) and lower portion(s)). This may facilitate a removal of the cavity filler from the cavity and/or may reduce a likelihood of damage to the cavity filler during removal from the cavity. For example, a high-viscosity lubricant between an inner surface or wall of the cavity of the gate valve or with a surface of a bonnet of the gate valve and an outer surface of the cavity filler may make the cavity filler difficult to remove from the cavity. By separating the cavity filler into an upper portion and a lower portion, the portions can be removed separately. Additionally, fragile portions of the cavity filler (e.g., near the aperture of the cavity filler) may be removed to mitigate a likelihood that the cavity filler is damaged during removal from the cavity.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations cannot be combined. Even though particular combinations of features are recited in the claims and/or disclosed in the specification, these combinations are not intended to limit the disclosure of various implementations. Although each dependent claim listed below may directly depend on only one claim, the disclosure of various implementations includes each dependent claim in combination with every other claim in the claim set.

As used herein, “a,” “an,” and a “set” are intended to include one or more items, and may be used interchangeably with “one or more.” Further, as used herein, the article “the” is intended to include one or more items referenced in connection with the article “the” and may be used interchangeably with “the one or more.” Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A cavity filler for a gate valve, the cavity filler comprising:
a first body configured to be received within a cavity of the gate valve,
wherein the first body includes a first aperture configured to receive fluid passing through a fluid conduit of the gate valve, the fluid conduit defining a direction of flow, and
wherein the first body includes a first lip, extending in a direction parallel to the direction of flow, configured to receive a gate of the gate valve; and
a second body configured to be received within the cavity of the gate valve,
wherein the second body includes a second aperture configured to receive the fluid passing through the fluid conduit, and
wherein the second body includes a second lip, extending in the direction parallel to the direction of flow, configured to receive the gate of the gate valve.

2. The cavity filler of claim 1, wherein the first body is configured in the cavity of the gate valve upstream relative to the gate of the gate valve and the direction of flow, and
wherein the second body is configured in the cavity of the gate valve downstream relative to the gate of the gate valve and the direction of flow.

3. The cavity filler of claim 1, wherein the first body is an upper portion and the second body is a lower portion, and
wherein the first body is configured in the cavity of the gate valve above the second body with respect to the fluid conduit.

4. The cavity filler of claim 1, wherein the first body includes a first upper portion and a first lower portion separated by a distance, and
wherein the second body includes a second upper portion and a second lower portion separated by the distance.

5. The cavity filler of claim 4, wherein the first upper portion and the second upper portion are connected via a first one or more brackets, and
wherein the first lower portion and the second lower portion are connected via a second one or more brackets.

6. The cavity filler of claim 1, further comprising:
one or more fluid pathways, disposed on at least one of the first body or the second body, configured to enable fluid to pass between a first surface of the cavity filler and a second surface of the cavity filler.

7. The cavity filler of claim 1, wherein the first body and the second body collectively define a substantially circular cross-section of the cavity filler; and
wherein the first lip and the second lip define a third aperture through the cavity filler extending perpendicular to the direction of flow, wherein the third aperture defines a substantially rectangular cross-section configured to receive the gate of the gate valve.

8. The cavity filler of claim 1, wherein the first body and the second body are separated by a distance when configured within the cavity of the gate valve, wherein the distance extends perpendicular to the direction of flow, and wherein the distance enables a valve seat of the gate valve to be received by the cavity filler.

9. A gate valve, comprising:
a housing defining a cavity, wherein the housing includes an outlet and an inlet for a fluid conduit that is configured between the outlet and the inlet, wherein the fluid conduit defines an axis;
a gate moveably configured within the cavity, wherein the gate is configured to be moveable between an open position and a closed position, and wherein the open position enables fluid to pass through the fluid conduit and the closed position prevents fluid from passing through the fluid conduit; and
a cavity filler configured within the cavity, wherein the cavity filler occupies a volume of the cavity, and wherein the cavity filler includes one or more bodies that restrict a movement of the gate to a first direction that is perpendicular to the axis.

10. The gate valve of claim 9, wherein the cavity filler includes one or more lips that extend from the one or more bodies in a second direction that is parallel to the axis, wherein the one or more lips are configured to receive the gate, and wherein the one or more lips restrict the movement of the gate to the first direction.

11. The gate valve of claim 10, wherein the cavity filler defines a substantially circular cross-section, wherein the one or more lips define an aperture in the cavity filler that extends in the first direction, and wherein the aperture defines a substantially rectangular cross-section.

12. The gate valve of claim 9, wherein the one or more bodies include a first body and a second body, wherein the gate includes a first side and a second side, and wherein the first body is configured within the cavity proximate to the first side, relative to the axis, and the second body is configured within the cavity proximate to the second side relative to the axis.

13. The gate valve of claim 9, wherein the one or more bodies include a first body and a second body,
wherein the first body is configured within the cavity above the outlet and the inlet, and
wherein the second body is configured within the cavity below the outlet and the inlet.

14. The gate valve of claim 13, wherein the first body and the second body are separate pieces that are separated by a distance within the cavity.

15. A cavity filler for a gate valve, comprising:
a body defining a substantially cylindrical configuration, a cylindrical axis, a top surface, a bottom surface, and an outer surface, wherein the body is configured to be received within a cavity of the gate valve;
an aperture extending through the body in a first direction that is perpendicular to the cylindrical axis, wherein the aperture is configured to receive fluid passing through a fluid conduit of the gate valve; and
a channel extending through the body in a second direction that is parallel to the cylindrical axis, wherein the channel is configured to receive a gate of the gate valve, and wherein the channel is configured to restrict a movement of the gate to a plane that is parallel to the cylindrical axis.

16. The cavity filler of claim 15, wherein the body includes a first body and a second body,
wherein the first body defines an upper portion of the aperture, and
wherein the second body defines a lower portion of the aperture.

17. The cavity filler of claim 16, further comprising:
one or more braces extending between the first body and the second body, wherein the one or more braces are configured to prevent a rotation of the first body with respect to the second body.

18. The cavity filler of claim 15, further comprising:
one or more lips extending from the body in a third direction that is parallel to a direction of flow, and wherein the one or more lips and the body define the channel.

19. The cavity filler of claim 18, wherein the body prevents a movement of the gate in the first direction, wherein the one or more lips prevent a movement of the gate in a fourth direction relative to the plane, and wherein the cavity filler restricts a rotational movement of the gate relative to the plane.

20. The cavity filler of claim 15, wherein the body includes a first body and a second body, and wherein the first body and the second body define the channel.
